(19) United States
(12) Patent Application Publication
(10) Pub. No.: US 2025/0322280 A1
(43) Pub. Date: Oct. 16, 2025

(54) APPARATUS FOR PROVIDING BELL FUSION BASED ON ERROR CORRECTION

(71) Applicant: KOREA INSTITUTE OF SCIENCE AND TECHNOLOGY, Seoul (KR)

(72) Inventors: Seung-Woo LEE, Seoul (KR); Wooyeong SONG, Seoul (KR); Nuri KANG, Seoul (KR); Sang Wook HAN, Seoul (KR); Yong-Su KIM, Seoul (KR); Hyang-Tag LIM, Seoul (KR); Hojoong JUNG, Seoul (KR)

(73) Assignee: KOREA INSTITUTE OF SCIENCE AND TECHNOLOGY, Seoul (KR)

(21) Appl. No.: 18/773,137

(22) Filed: Jul. 15, 2024

(30) Foreign Application Priority Data
Apr. 12, 2024 (KR) 10-2024-0049475

(51) Int. Cl. G06N 10/40; B82Y 10/00; G01J 1/44; G06N 10/60; H04B 10/70

(52) U.S. Cl. CPC G06N 10/40; B82Y 10/00; G01J 1/44; G06N 10/60; H04B 10/70

(57) ABSTRACT

An apparatus for providing Bell fusion comprises a measurement unit configured to apply a Bell fusion operator to a plurality of Bell blocks corresponding to pairs of photons in a quantum entanglement state to sequentially measure a zeroth level of a Bell state for each of the plurality of Bell blocks; a selection unit configured to select a Bell fusion operator to be applied to a next Bell block of the plurality of Bell blocks based on a result of measuring a zeroth level of Bell state for a previous Bell block corresponding to the next Bell block; and an identification unit configured to identify a first level of Bell state for a Bell box including the plurality of Bell blocks based on a result of measuring a zeroth level of Bell state for each of the plurality of Bell blocks.

### DESCRIPTION OF GOVERNMENT-SPONSORED RESEARCH

This research was supported by the Ministry of Science and ICT [Project Number: 1711181243, Subproject Number: 2022M3E4A1043330, Project Title: Quantum Computing Technology Development Project, Project Title: Research on High Brightness and High Quality Quantum Entanglement States Generation Using Noncritical Phase Matching].

This research was supported by the Ministry of Science and ICT [Project Number: 1711198025, Subproject Number: 2022M3K4A1094774, Project Name: Inter-Country Cooperation Base Creation, Project Title: Development of Core Original Technology for Implementing Quantum Error Correction].

### CROSS REFERENCE TO RELATED APPLICATIONS

The present application claims the benefit under 35 USC 119 (a) of Korean Patent Application No. 10-2024-0049475 filed on Apr. 12, 2024, in the Korean Intellectual Property Office, the entire disclosure of which is incorporated herein by reference for all purposes.

### BACKGROUND OF THE INVENTION

### Field of the Invention

Disclosed embodiments relate to a technology for providing Bell fusion using linear optics, and more specifically, a technology for performing Bell fusion that is accomplished by performing quantum error correction on quantum states in a feed-forward method.

### Description of the Related Art

Bell fusion means a measurement process that identifies a quantum entanglement state referred to as a Bell state. The Bell fusion is an essential core technology that is periodically used in quantum computing and quantum communication and the like, and is being used in various fields of quantum technology.

However, the ideal maximum success probability for the Bell fusion using photons and linear optics is 50%. In consideration of the photon losses that occur in real implemented environments, the actual success probability is less than 50%. That is, the success probability of performing a quantum apparatus in which the Bell fusion is used periodically decreases exponentially. Therefore, the low success probability of the Bell fusion and the problems caused by photon losses need to be overcome for the development of quantum technology.

In particular, a recent study proposes a measurement-based quantum computing in a method that directly uses the Bell fusion for computation. Fusion-based quantum computing enhances the implementation convenience of not having to prepare large-sized quantum entanglement states in advance. However, the low success probability of the Bell fusion and the effect of photon losses have a direct effect on quantum computing performance. That is, the success probability of the Bell fusion technology and the problem of reducing the effect of photon losses are important issues for improving the performance of quantum computing.

### DOCUMENTS OF RELATED ART

(Patent Document 1) Korean Patent Publication No. 10-2023-0108333 (published on Jul. 18, 2023)

### SUMMARY OF THE INVENTION

Disclosed embodiments relate to a technology for providing Bell fusion accomplished by performing quantum error correction using linear optics.

There is provided an apparatus for providing Bell fusion, provided with one or more optical components and a processor, the apparatus may include: a measurement unit including one or more optical components and configured to apply a Bell fusion operator to a plurality of Bell blocks corresponding to pairs of photons in a quantum entanglement state to sequentially measure a zeroth level of a Bell state for each of the plurality of Bell blocks−the plurality of Bell blocks being distinguished as at least one of a previous Bell block or a next Bell block, depending on a sequence in which each of the plurality of Bell blocks is calculated −; a selection unit including one or more processors and configured to select a Bell fusion operator to be applied to a next Bell block of the plurality of Bell blocks based on a result of measuring a zeroth level of Bell state for a previous Bell block corresponding to the next Bell block; and an identification unit including one or more optical components and configured to identify a first level of Bell state for a Bell box including the plurality of Bell blocks based on a result of measuring a zeroth level of Bell state for each of the plurality of Bell blocks.

The Bell fusion operator may include at least two Bell fusion operators of a first Bell fusion operator configured to identify a first state of the zeroth level, a second Bell fusion operator configured to identify a second state of the zeroth level, or a third Bell fusion operator configured to identify a third state of the zeroth level.

The selection unit may select the second Bell fusion operator or the third Bell fusion operator as an operator to be applied to the next Bell block when measurement of a zeroth level of Bell state for the previous Bell block by applying the first Bell fusion operator to the previous Bell block is successful or photon losses are detected.

The selection unit may apply the second Bell fusion operator or the third Bell fusion operator to an entirety of the next Bell block simultaneously and all at once when the measurement of the zeroth level of Bell state for the previous Bell block by applying the first Bell fusion operator to the previous Bell block is successful or photon losses are detected.

The selection unit may select the first Bell fusion operator as an operator to be applied to the next Bell block when measurement of a zeroth level of Bell state for the previous Bell block by applying the first Bell fusion operator to the previous Bell block fails.

The selection unit may select the second Bell fusion operator or the third Bell fusion operator as an operator to be applied to the next Bell block when the measurement of the zeroth level of Bell state for the previous Bell block by applying the first Bell fusion operator to the previous Bell block continuously fails for a preset number of times or more.

The selection unit may apply the second Bell fusion operator or the third Bell fusion operator to an entirety of the next Bell block simultaneously and all at once when the measurement of the zeroth level of Bell state for the previous Bell block by applying the first Bell fusion operator to the previous Bell block continuously fails for a preset number of times or more.

The second Bell fusion operator may be configured to identify a Bell state of a qubit that is indistinguishable via the first Bell fusion operator, and the third Bell fusion operator may be configured to identify a Bell state of a qubit that is indistinguishable via the first Bell fusion operator and the second Bell fusion operator.

The identification unit may identify the first level of Bell state for a Bell box including the plurality of Bell blocks based on a result of measuring the zeroth level of Bell state for each of the plurality of Bell blocks.

The identification unit may identify the first level of Bell state to be a state in which all input pairs of photons are entangled with each other when no photon losses are detected upon Bell state measurement for all of the plurality of Bell blocks by applying the first Bell fusion operator to each of the plurality of Bell blocks.

The identification unit may determine signs of all input pairs of photons to identify the first level of Bell state when Bell state measurement for some of the plurality of Bell blocks is successful or photon losses are not detected by applying the first Bell fusion operator to each of the plurality of Bell blocks.

The identification unit may identify a second level of Bell state for a Bell network including the plurality of Bell boxes on the basis of a first level for each of the Bell boxes.

In the disclosed embodiments, a Bell state measurement can be achieved using linear optics, thereby enhancing implementation feasibility compared to existing technologies.

In the disclosed embodiments, quantum errors correction may be achieved through a hierarchical Bell state measurement in a feed-forward method, thereby increasing the success probability of fusion.

In the disclosed embodiments, limiting the number of failure for the Bell state measurement can improve the efficiency of quantum error correction while also improving the limitation of photon losses.

### BRIEF DESCRIPTION OF THE DRAWINGS

FIG. 1 is a block diagram for describing an apparatus for providing Bell fusion according to one embodiment.

FIG. 2 is an exemplified view for describing an operating process of the apparatus for providing Bell fusion according to one embodiment.

FIG. 3 is an exemplified view for describing a Bell fusion operator in one example.

FIGS. 4A through 4C are exemplified views for describing a process in which an operator of a Bell block is selected in one example.

FIG. 5 is a graph for describing the performance of the apparatus for providing Bell fusion according to one embodiment.

FIG. 6 is a graph for describing the performance of the apparatus for providing Bell fusion according to one embodiment.

### DETAILED DESCRIPTION OF THE INVENTION

Hereinafter, specific exemplary embodiments of one embodiment will be described with reference to the drawings. The following detailed description is provided to assist in the comprehensive understanding of a method, an apparatus, and/or a system described in the present specification. However, the exemplary embodiments are provided only for illustrative purpose, and the present invention is not limited thereto.

In addition, in the description of the exemplary embodiments, the specific descriptions of publicly known technologies related with the present invention will be omitted when it is determined that the specific descriptions may unnecessarily obscure the subject matter of the exemplary embodiments. In addition, the terms used herein are defined considering the functions in the present invention and may vary depending on the intention or usual practice of a user or an operator. Therefore, the definition of the present disclosure should be made based on the entire contents of the present specification. The terms used in the detailed description are provided only for describing the exemplary embodiments and should not be restrictive. Unless explicitly used otherwise, singular expressions include plural expressions thereof. In the present specification, the terms “comprises,” “comprising,” “includes,” “including,” “containing,” “has,” “having” or other variations thereof are provided to indicate specific components, numbers, steps, operations, elements, and some or combinations thereof, and it should not be construed to exclude the presence or possibility of one or more other components, numbers, steps, operations, elements, and some or combinations thereof other than those disclosed.

Terms “first”, “second”, and the like may be used to describe various constituent elements, but the constituent elements are of course not limited by these terms. These terms are merely used to distinguish one constituent element from another constituent element. Therefore, the first constituent element mentioned hereinafter may be the second constituent element within the technical spirit of the present invention. As used in the description of the disclosure and claims, the singular forms “a”, “an”, and “the” are intended to include the plural forms as well, unless the context clearly indicates otherwise.

In addition, the embodiments disclosed in the present specification may have a configuration that is hardware as a whole, hardware partially, software partially, or software as a whole.

In the present specification, “unit,” “device,” and the like refer to any combination of hardware, software, and the like. For example, the unit, device, and the like may refer to the integrated photonic circuit itself including optical components or to hardware and software connected to the hardware to drive the integrated photonic circuit.

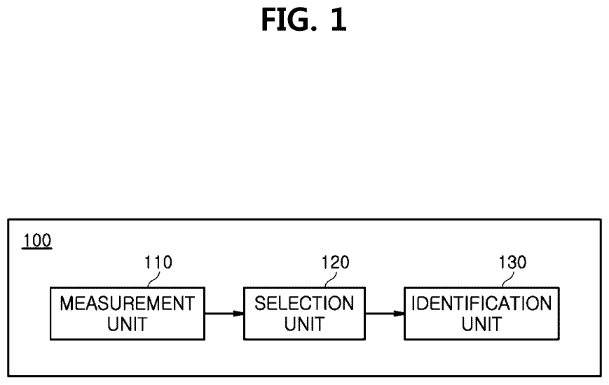

FIG. 1 is a block diagram for describing an apparatus 100 for providing Bell fusion according to one embodiment.

With reference to FIG. 1, the apparatus 100 for providing Bell fusion includes a measurement unit 110, a selection unit 120, and an identification unit 130.

The measurement unit 110 measures a zeroth level of Bell states for each of a plurality of Bell blocks 10. The measurement unit 110 may measure the zeroth level of Bell state for each of the plurality of Bell blocks 10 using one or more optical components.

Here, the Bell block 10 is a concept that means a set of quantum bits, that is, qubits, in a state of quantum entanglement. That is, an entangled structure of quantum bits of a pair of photons may be expressed in units of Bell blocks. In this case, a quantum state of the pair of photons is referred to as a photon-level Bell state.

That is, a set of quantum bits for each of n pairs of photons with quantum entanglement states may be expressed in units of Bell blocks in the corresponding n Bell blocks 10-1 to 10-n.

The measurement unit 110 may apply a Bell fusion operator 1 to the plurality of Bell blocks 10 to sequentially measure the zeroth level of Bell state for each of the plurality of Bell blocks 10.

In this case, the zeroth level of Bell state may mean a Bell state that a pair of photons have.

The measurement unit 110 may apply the Bell fusion operator 1 to the Bell block 10 corresponding to a pair of photons in a quantum entanglement state.

For example, the measurement unit 110 may apply the Bell fusion operator 1 to a first Bell block 10 corresponding to a first pair of photons in a quantum entanglement state. Then, the measurement unit 110 may apply the Bell fusion operator 1 to a second Bell block 10-2 corresponding to a second pair of photons in a quantum entanglement state.

In this case, the Bell fusion operator 1 is an operator for distinguishing Bell states, which are quantum states entangled in different types, and the four Bell states to be distinguished may be expressed as a combination of letter signs Φ and Ψ and negative and positive signs + and −, as shown in [Equation 1].

$$\{ \vert {Φ}^{+} 〉 , \vert {Φ}^{-} 〉 , \vert {Ψ}^{+} 〉 , \vert {Ψ}^{-} 〉 \} \qquad [ Equation 1 ]$$

The Bell fusion operator 1 may include at least some of a first Bell fusion operator 1-1, a second Bell fusion operator 1-2, and a third Bell fusion operator 1-3, as shown below, for distinguishing each sign of a Bell state.

The second Bell fusion operator 1-2 may be configured to identify a sign of a Bell state for which the first Bell fusion operator 1-1 is unable to identify, and the third Bell fusion operator 1-3 may be configured to identify a sign of a Bell state for which the first Bell fusion operator 1-1 and the second Bell fusion operator 1-2 are unable to identify.

As a specific example, the Bell fusion operator 1 may include at least two of the first Bell fusion operator 1-1, the second Bell fusion operator 1-2, and the third Bell fusion operator 1-3 to identify a first state where a sign of the zeroth level of Bell state is Ψ′, a second state where the sign of the zeroth level of Bell state is +, and a third state where the sign of the zeroth level of Bell state is −, respectively.

A set of the Bell fusion operator 1 may be expressed as [Equation 2].

$$B = \{ {B}_{ψ} , {B}_{+} , {B}_{-} \} \qquad [ Equation 2 ]$$

In this case, B may mean the Bell fusion operator 1, and B_{ψ}, B₊, and B₋ may mean the first Bell fusion operator 1-1, the second Bell fusion operator 1-2, and the third Bell fusion operator 1-3, respectively.

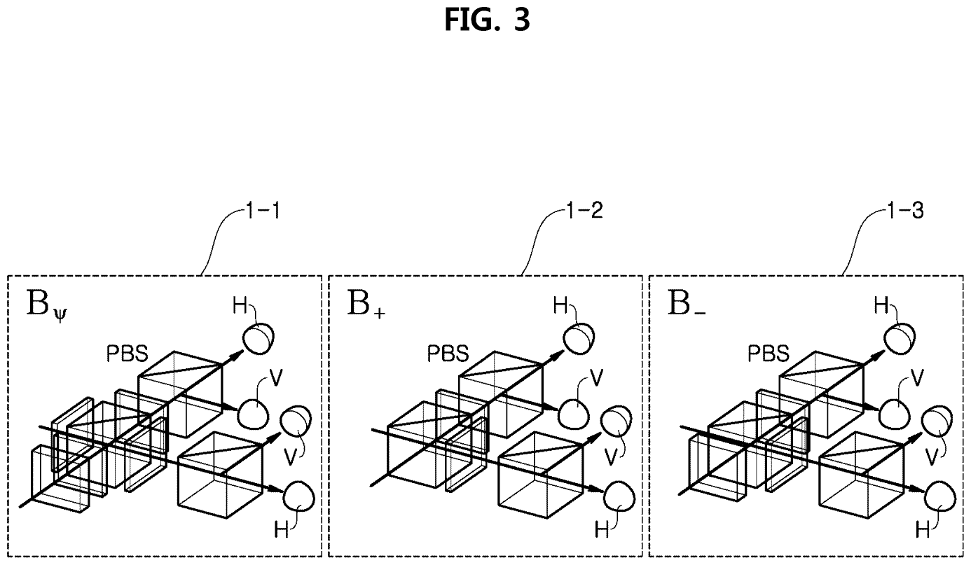

Meanwhile, the Bell fusion operator 1 may be configured through at least one of a polarization filter (e.g., a quarter-wave plate (QWP), a half-wave plate (HWP)), a polarization beam splitter (PBS), and a photon detector. A structure for the Bell fusion operator 1 is described below in detail in FIG. 3.

The measurement unit 110 may measure the zeroth level of Bell state for a random Bell block 10 as one of the first state to the third state when the measurement is successful, as shown in Equation 3 below.

$${B}_{t} ( 0 ) = \{ \begin{matrix}First state : ( \vert {ψ}^{+} 〉 or \vert {ψ}^{-} 〉 ) \\ Second state : ( \vert {φ}^{+} 〉 or \vert {ψ}^{+} 〉 ) \\ Third state : ( \vert {φ}^{-} 〉 or \vert {ψ}^{-} 〉 )\end{matrix} \qquad [ Equation 3 ]$$

Meanwhile, measurement failure is a case in which a result where a sign that an operator is trying to distinguish is not distinguishable is obtained, in a Bell fusion operator measurement unit comprising a linear optical instrument, and may be a case except when the Bell state measurement is successful and when photon losses are detected in the Bell state measurement.

Bₜ(0) means the zeroth level of Bell state for a t-th Bell block, and (|ψ⁺ [symbol] or |ψ⁻ [symbol] ), (|φ⁺ [symbol] or |ψ⁺ [symbol] ), (|φ⁻ [symbol] or |ψ⁻ [symbol] ) may mean the first state to the third state, respectively.

The selection unit 120 selects the Bell fusion operator 1 to be applied to a next Bell block on the basis of a result of measuring a zeroth level of Bell state of a previous Bell block that corresponds to the next Bell block among the plurality of Bell blocks 10. The selection unit 120 may select the Bell fusion operator 1 to be applied to a next Bell block on the basis of a result of measuring a zeroth level of Bell state of a previous Bell block using one or more processors.

In this case, the previous Bell block and the next Bell block are distinguished according to the sequence of calculations. As described above, the first Bell block 10-1 may correspond to a previous Bell block on the second Bell block 10-2, and the second Bell block 10-2 may correspond to a next Bell block on the first Bell block 10-1.

Meanwhile, it is intended that the second Bell block as well as the first Bell block 10-1 may be included in a previous Bell block of the third Bell block 10-3. That is, it is interpreted that the previous Bell block includes not only the immediately preceding Bell block, but also the Bell block for which the Bell calculation has already been completed.

In one example, when the first Bell fusion operator 1-1 is applied to a previous Bell block and the measurement of a zeroth level of Bell state for the previous Bell block is successful or photon losses are detected during the measurement, the selection unit 120 may select the second Bell fusion operator 1-2 or the third Bell fusion operator 1-3 as an operator to be applied to a next Bell block.

In one example, when the first Bell fusion operator 1-1 is applied to a previous Bell block and the measurement of a zeroth level of Bell state for the previous Bell block fails, the selection unit 120 may select the first Bell fusion operator 1-1 as an operator to be applied to a next Bell block.

In another example, when the first Bell fusion operator 1-1 is applied to a previous Bell block and the measurement of a zeroth level of Bell state for the previous Bell block continuously fails for a preset number of times or more, the selection unit 120 may select the second Bell fusion operator 1-2 or the third Bell fusion operator 1-3 as an operator to be applied to a next Bell block.

As another example, when the second Bell fusion operator 1-2 or the third Bell fusion operator 1-3 is applied to a previous Bell block, the selection unit 120 may select the second Bell fusion operator 1-2 or the third Bell fusion operator 1-3 as an operator to be applied to a next Bell block.

In this case, the second Bell fusion operator 1-2 may be an operator configured to identify a Bell state of any one qubit measured in the first Bell fusion operator 1-1. The third Bell fusion operator 1-3 may be an operator configured to identify a Bell state of another one qubit measured in the first Bell fusion operator 1-1.

Meanwhile, the second Bell fusion operator 1-2 and the third Bell fusion operator 1-3 are intended to include an operator set to identify the same as a sign of a quantum state revealed by the first Bell fusion operator 1-1 using the characteristics of symmetry and entanglement of the Bell state, or an operator set to identify that the quantum state has changed symmetrically.

The identification unit 130 identifies a first level of Bell state for a Bell box that includes the plurality of Bell blocks 10 on the basis of the result of measuring the zeroth level of Bell state for each of the plurality of Bell blocks 10.

The identification unit 130 may identify the first level of Bell state for a Bell box 20 on the basis of the number of times of measurement failure of a Bell state for each of the plurality of Bell blocks 10. The identification unit 130 may identify the first level of Bell state for the Bell box 20 on the basis of the number of times of measurement failure of a Bell state for each of the plurality of Bell blocks 10 using one or more optical components.

In this case, the first level of Bell state is a Bell state that is generated by integrating the zeroth level of Bell states for all Bell blocks 10. In other words, the first level of Bell state is a state in which the quantum states of all pairs of photons input are expressed.

In one example, the identification unit 130 may identify the first level of Bell state as a state in which all pairs of photons input are entangled when the first Bell fusion operator 1-1 is applied to each of the plurality of Bell blocks 10 and no photon loss is detected during the measurement of the Bell state for all of the plurality of Bell blocks 10.

In another example, the identification unit 130 may determine the signs of all pairs of photons input to identify the first level of Bell state when the first Bell fusion operator 1-1 is applied to each of the plurality of Bell blocks 10 and the Bell state measurement for the plurality of Bell blocks 10 is successful at least once, or when photon losses are not detected upon application of the second operator 1-2 and the third operator 1-3.

That is, the measurement unit 110 may measure the first level of Bell state for the t-th Bell box as either the first state or the second state, as shown in Equation 4 below.

$${B}_{t} ( 1 ) = \{ \begin{matrix}First state : \vert {ψ}_{( m )}^{+} 〉 or \vert {ψ}_{( m )}^{-} 〉 or \vert {φ}_{( m )}^{+} 〉 or \vert {φ}_{( m )}^{-} 〉 \\ Second state : state identified as sign of + or -\end{matrix} \qquad [ Equation 4 ]$$

Bₜ(1) may mean the first level of Bell state for a t-th Bell block,

$$\vert {ψ}_{( m )}^{\pm } 〉$$

may mean the state of |+^{(m)} [symbol] |−^{(m)} [symbol] ±|−^{(m)}|+^{(m)} [symbol] , and

$$\vert {φ}_{( m )}^{\pm } 〉$$

may mean the state of |+^{(m)} [symbol] |+^{(m)} [symbol] ±|−^{(m)}|−^{(m)} [symbol] .

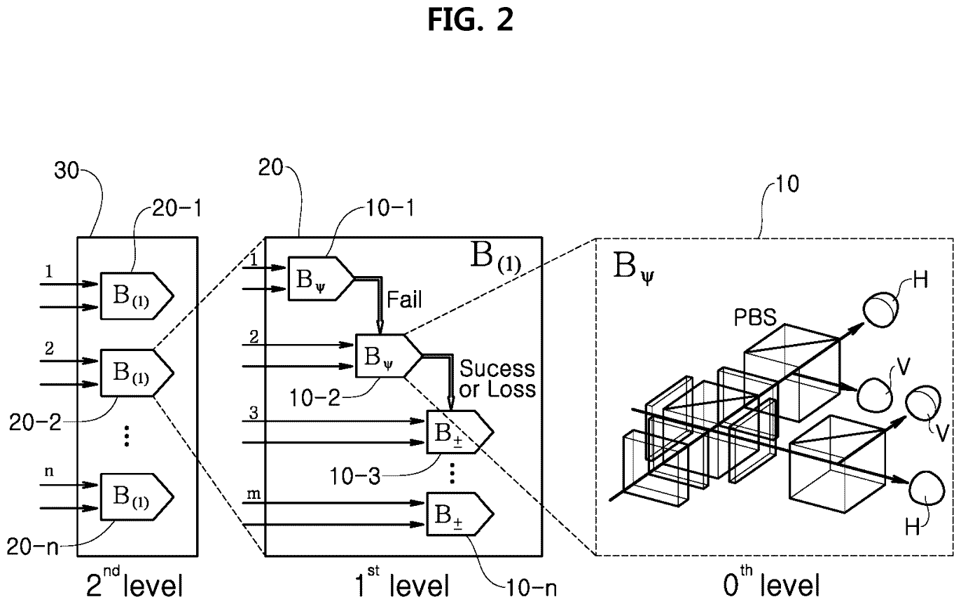

FIG. 2 is an exemplified view for describing an operating process of the apparatus 100 for providing Bell fusion according to one embodiment.

The apparatus 100 for providing Bell fusion performs a hierarchical Bell state measurement. In other words, the apparatus 100 for providing Bell fusion identifies the zeroth level to second level of Bell states sequentially to perform Bell state measurements for all pairs of photons in a hierarchical manner.

The apparatus 100 for providing Bell fusion measures the zeroth level of Bell state for each of the m Bell blocks 10. Then, the apparatus 100 for providing Bell fusion identifies the first level of Bell state for the Bell box 20, which includes m Bell blocks 10. The apparatus 100 for providing Bell fusion identifies the second level of Bell state for a Bell network 30 that includes n Bell boxes 20. That is, apparatus 100 for providing Bell fusion may identify the quantum state of 2 nm photons, i.e., nm pairs of photons that are input.

Specifically, the apparatus 100 for providing Bell fusion measures a Bell state for one Bell block 10 using the Bell fusion operator 1. In this case, the apparatus 100 for providing Bell fusion measures the zeroth level of Bell state for each of the Bell blocks 10.

The apparatus 100 for providing Bell fusion determines an operator to be applied to the n Bell blocks 10. The apparatus 100 for providing Bell fusion performs the zeroth level of Bell state measurement based on a feed-forward method to alternately perform the Bell state measurement and operator selection.

For example, when the apparatus 100 for providing Bell fusion applies the first Bell fusion operator 1-1 for a previous Bell block and fails to measure the first state, the apparatus applies the first Bell fusion operator 1-1 again for a next Bell block.

In this case, the first Bell fusion operator 1-1 may be an operator that identifies whether the pair of photons has |ψ^{±} [symbol] as the first state. In this case, |ψ^{±} [symbol] may mean state (|+ [symbol] |− [symbol] ±|− [symbol] |+ [symbol] )/\sqrt{2}. Meanwhile, |±^{(m)} [symbol] may be expressed as (|H [symbol] ^{⊗(m)}±|V [symbol] ^{⊗(m)})/\sqrt{2}.

In contrast, when the apparatus 100 for providing Bell fusion applies the first Bell fusion operator 1-1 for a previous Bell block, and succeeds in measuring the first state or detects photon losses during the measurement, the apparatus applies the second Bell fusion operator 1-2 or the third Bell fusion operator 1-3 for a next Bell block.

In this case, the second Bell fusion operator 1-2 or the third Bell fusion operator 1-3 may measure whether the next pair of photons has one of |φ^{±} [symbol] . In this case, |φ^{±} [symbol] may mean state (|+ [symbol] |+ [symbol] ±|− [symbol] |− [symbol] )/\sqrt{2}.

Meanwhile, the Bell block 10 is an intangible concept representing a quantum state, but for convenience of description, in FIG. 2, the Bell block 10 is illustrated as an imaginary space, occupying a space occupied by the Bell fusion operator 1.

The apparatus 100 for providing Bell fusion may identify the first level of Bell state for the Bell box 20 that includes the plurality of Bell blocks 10 by summing the zeroth level of Bell state for each Bell block 10.

In other words, the apparatus 100 for providing Bell fusion may identify a Bell state for all pairs of photons input to the Bell box 20.

For example, when photon losses are not detected during the Bell state measurement for all of the plurality of Bell blocks 10 included in the first Bell box 20-1, the apparatus 100 for providing Bell fusion may identify that all pairs of photons input to the first Bell box 20-1 are in a quantum entanglement state.

Specifically, the apparatus 100 for providing Bell fusion may identify all pairs of photons input to the Bell box 20 as

$$\vert {φ}_{( m )}^{\pm } 〉 and \vert {ψ}_{( m )}^{\pm } 〉 .$$

In this case, m is the number of pairs of photons input to one Bell box 20. In other words, m is also the number of Bell blocks 10 that are included in the Bell box 20.

In another example, the apparatus 100 for providing Bell fusion may identify the sign +, − of all pairs of photons input to the second Bell box 20-2 by determining the sign +, − of the pairs of photons input when the first operator 1-1 is applied to the plurality of Bell blocks 10 included in the second Bell box 20-2 and the Bell state measurement is successful at least once, or when no photon losses are detected upon application of the second operator 1-2 and the third operator 1-3.

Then, the apparatus 100 for providing Bell fusion may identify the second level of Bell state for the Bell network 30, which includes the plurality of Bell blocks 20.

The apparatus 100 for providing Bell fusion may identify the Bell network 30 as a logical Bell state having |Φ^{±} [symbol] and |Ψ^{±} [symbol] in the case of the first state identified as |Φ^{±} [symbol] or |Ψ^{±} [symbol] in at least one Bell box of the plurality of Bell boxes 20 included in the Bell network 30, and the second state identified as sign of +, − in the remaining Bell boxes.

Here, |Φ^{±} [symbol] may mean the state of |0_{L} [symbol] |0_{L} [symbol] ±|1_{L} [symbol] |1_{L} [symbol] and |Ψ^{±} [symbol] may mean the state of |0_{L} [symbol] |1_{L} [symbol] ±|1_{L} [symbol] |0_{L} [symbol] Here, |0_{L} [symbol] may mean |+^{(m)} [symbol] ^{⊗(n)} and |1_{L} [symbol] may mean |−^{(m)} [symbol] ^{⊗(n)}. Meanwhile, m may mean the number of Bell blocks 10 and n may mean the number of Bell boxes 20.

FIG. 3 is an exemplified view for describing the Bell fusion operator 1 in one example.

With reference to FIG. 3, the apparatus 100 may be configured using the Bell fusion operator 1. For example, the Bell fusion operator 1 may be configured using a polarization beam splitter, and a wave plate and a photon detector, and may be implemented in a device or chip such that the function logically equivalent thereto is performed.

In the Bell fusion operator 1, the photon detector is designed to detect a polarization state in a vertical direction and a polarization state in a horizontal direction of a light wave symmetrically according to a traveling direction of the light wave, respectively.

Hereinafter, a difference between the first Bell fusion operator 1-1 and the third Bell fusion operator 1-3 is as follows.

The first Bell fusion operator 1-1 may be implemented using one half-wave plate, four quarter-wave plates and a beam splitter.

The second Bell fusion operator 1-2 may be implemented by removing one half-wave plate and two quarter-wave plates that pass through two types of input modes from the first Bell fusion operator 1-1.

The second Bell fusion operator 1-2 may be implemented by removing all wave plates that pass through two types of input modes from the first Bell fusion operator 1-1.

The third Bell fusion operator 1-3 may be implemented by removing two quarter-wave plates that pass through two types of input modes from the first Bell fusion operator 1-1.

The Bell fusion operator 1 used in the apparatus 100 for providing Bell fusion according to one embodiment may be provided as a linear optical component, thereby increasing the implementation feasibility.

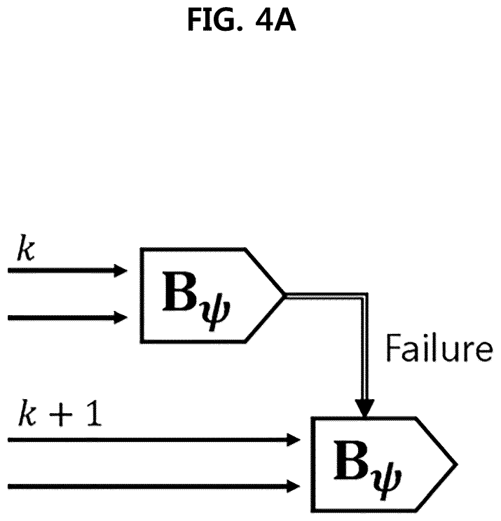

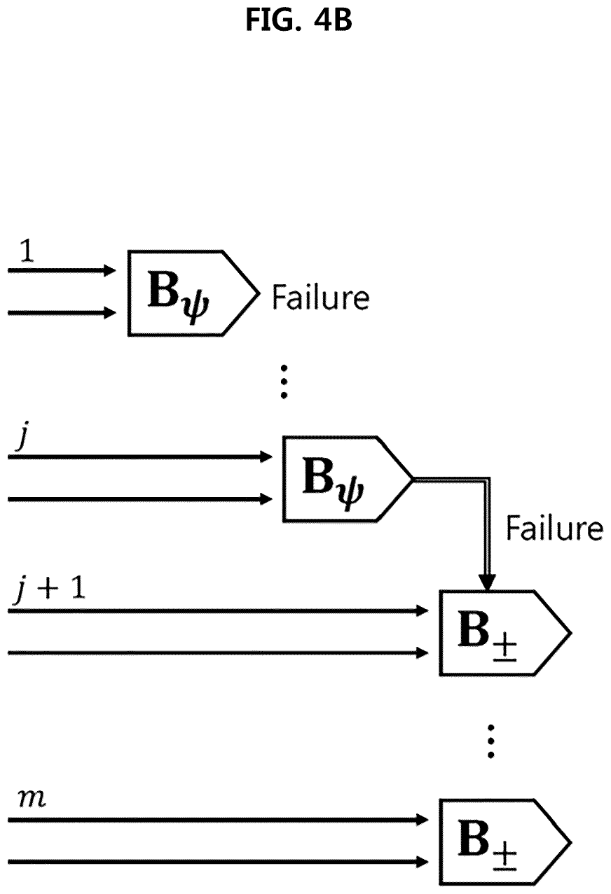

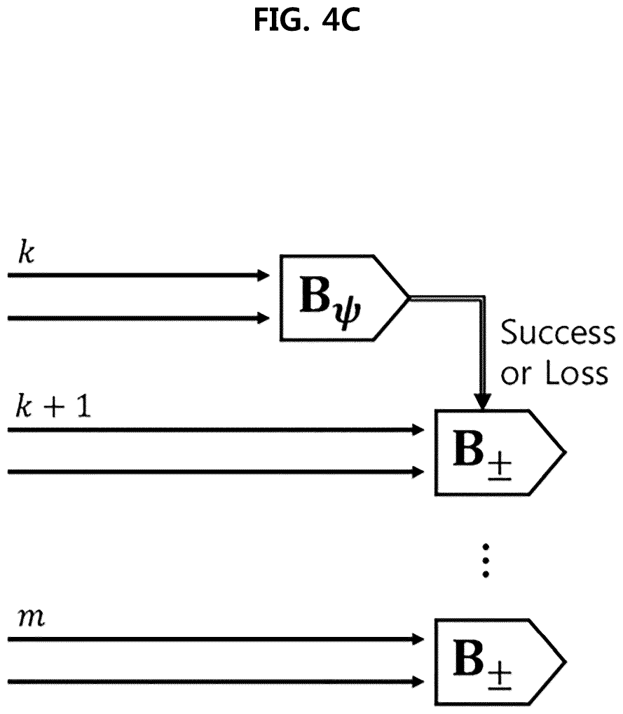

FIGS. 4A through 4C are exemplified views for describing a process in which an operator of the Bell block 10 is selected in one example.

With reference to FIG. 4A, the first Bell fusion operator 1-1 is applied to a k-th Bell block corresponding to a k-th input pair of photons. The first Bell fusion operator 1-1 is applied to a k+1-th Bell block corresponding to a k+1-th input pair of photons.

The Bell fusion operator 1 is determined to be applied to the k+1-th Bell block on the basis of a result of a Bell calculation according to the application of the first Bell fusion operator 1-1 of the k Bell block. Specifically, when the first Bell fusion operator 1-1 is applied to the k-th Bell block, but it fails to measure that the state of the corresponding pair of photons is the first state, the first Bell fusion operator 1-1 is applied again to the k+1-th Bell block.

With reference to FIG. 4B, the first Bell fusion operator 1-1 is applied to the first to j-th Bell block corresponding to the first to j-th input pair of photons.

In the same manner as in FIG. 4A, in a state where the first Bell fusion operator 1-1 is applied to the first to the j-th Bell block but does not measure that a state of the corresponding pair of photons is the first state, the first Bell fusion operator 1-1 is repeatedly applied to the first to the j-th Bell block.

However, when the first Bell fusion operator 1-1 is applied to a previous Bell block and the Bell state measurement continuously fails for a preset number of times or more, the apparatus 100 for providing Bell fusion may select the second Bell fusion operator 1-2 or the third Bell fusion operator 1-3 as an operator to be applied to a next Bell block.

For example, in FIG. 4B, when the preset number of times is j, the apparatus 100 for providing Bell fusion may apply the second Bell fusion operator 1-2 or the third Bell fusion operator 1-3 to a j+1-th Bell block 10.

Meanwhile, j is a natural number of 1 or more but m−1 or less, and m is the number of Bell blocks 10 included in the Bell box 20.

Meanwhile, when the Bell state measurement fails for the preset number of times of j or more, the second Bell fusion operator 1-2 or the third Bell fusion operator 1-3 may be applied to the remaining Bell blocks from the j+1-th Bell block to the m-th Bell block at the same time.

With reference to FIG. 4C, the first Bell fusion operator 1-1 is applied to the k-th Bell block corresponding to the k-th input pair of photons. The second Bell fusion operator 1-2 or the third Bell fusion operator 1-3 is applied to the k+1-th Bell block corresponding to the k+1-th input pair of photons.

When the apparatus 100 for providing Bell fusion measures that the state of the k-th pair of photons corresponding to the k-th Bell block is the first state or detects that photon losses have occurred during the measurement, after the first Bell fusion operator 1-1 is applied to the k-th Bell block, the apparatus 100 for providing Bell fusion applies the second Bell fusion operator 1-2 or the third Bell fusion operator 1-3 to the k+1-th Bell block.

Then, when applying the second Bell fusion operator 1-2 or the third Bell fusion operator 1-3 to a previous Bell block, the apparatus 100 for providing Bell fusion applies the second Bell fusion operator 1-2 or the third Bell fusion operator 1-3 to a next Bell block. For example, the apparatus 100 for providing Bell fusion applies the second Bell fusion operator 1-2 or the third Bell fusion operator 1-3 to the next subsequent Bell block 10, as illustrated in FIG. 4C.

Meanwhile, k is a natural number of 1 or more but m−1 or less, and m is the number of Bell blocks 10 included in the Bell box 20.

Meanwhile, when measuring that the state of the k-th pair of photons corresponding to the k-th Bell block is the first state, or detecting that photon losses have occurred during the measurement, the apparatus 100 for providing Bell fusion may apply the second Bell fusion operator 1-2 or the third Bell fusion operator 1-3 to the remaining Bell blocks from the k+1-th Bell block to the m-th Bell block simultaneously and all at once.

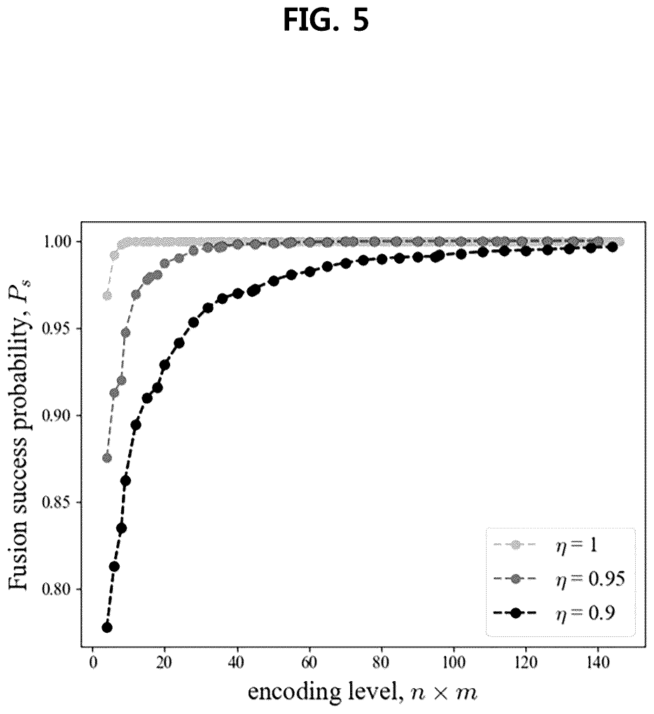

FIG. 5 is a graph for describing the performance of the apparatus 100 for providing Bell fusion according to one embodiment.

The graph illustrates the success probability of Bell fusion relative to the number of photons used in the Bell fusion by varying the photon loss rate. With existing technology, the ideal maximum success probability of Bell fusion using single photons and linear optics is 50%, but the actual success probability is less than 50% in consideration of the photon losses that occur in an actual implementation environment. However, the apparatus 100 for providing Bell fusion according to one embodiment may have a maximum success probability of 100%, and may have a success probability of 50% or more and closer to 100% even with the photon losses.

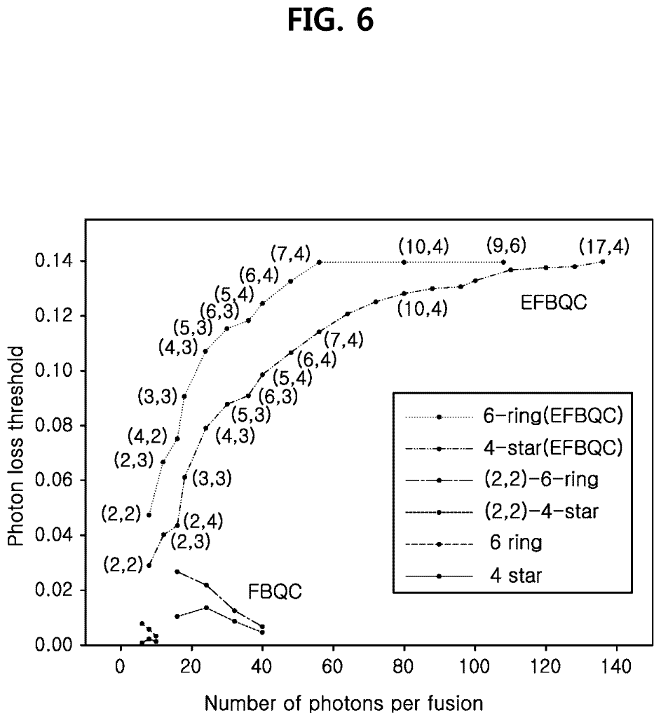

FIG. 6 is a graph for describing the performance of the apparatus 100 for providing Bell fusion according to one embodiment.

The graph illustrates results of applying Bell Fusion to measurement-based quantum computing, which is based on using Bell Fusion directly in computation.

The graph illustrates the photon loss threshold relative to the photons used in the Bell fusion. In this case, the photon loss threshold may mean the maximum allowable or tolerable photon loss to ensure a usable level of reliability of the computation result and make the quantum error correction or error compensation possible even if errors or defects occur due to photon loss when a photon-based quantum computing device is configured. The quantum computing device with a photon loss rate that exceeds the photon loss threshold may be damaged to such a level that the computation results are unreliable.

In the case of existing measurement-based quantum computing technologies that directly use the standard fusion scheme for computations, the maximum photon loss threshold is approximately 2.7% to 5%. However, the apparatus 100 for providing Bell fusion (e.g., 6-ring, 4-star based on EFBQC) according to one embodiment has the photon loss threshold of approximately 14% or more.

That is, the apparatus 100 for providing Bell fusion, according to one embodiment, can improve the allowable threshold of photon losses, which can dramatically improve the performance, feasibility, and range of applications of quantum computing.

Similarly, in the various quantum technologies in which Bell fusion is used, that is, quantum teleportation, quantum communications, quantum repeaters, and the like, the performance, feasibility improvements, and range of applications can be dramatically improved.

While the present invention has been described in detail above with reference to the representative exemplary embodiments, those skilled in the art to which the present invention pertains will understand that the exemplary embodiment may be variously modified without departing from the scope of the present invention. Therefore, the scope of the present invention should not be limited to the described exemplary embodiments, and should be defined by not only the claims to be described below, but also those equivalent to the claims.

### DESCRIPTION OF REFERENCE NUMERALS

1: Bell fusion operator
1-1: First Bell fusion operator
1-2: Second Bell fusion operator
1-3: Third Bell fusion operator
10: Bell block
10-1: First Bell block
10-2: Second Bell block
10-3: Third Bell block
10-n: n-th Bell block
20: Bell box
20-1: First Bell box
20-2: Second Bell box
20-3: Third Bell box
20-n: n-th Bell box
30: Bell network
100: Apparatus for providing Bell fusion
110: Measurement unit
120: Selection unit
130: Identification unit

What is claimed is:

1. An apparatus for providing Bell fusion configured to include one or more optical components and a processor, the apparatus comprising:
a measurement unit including one or more optical components and configured to apply a Bell fusion operator to a plurality of Bell blocks corresponding to pairs of photons in a quantum entanglement state to sequentially measure a zeroth level of a Bell state for each of the plurality of Bell blocks−the plurality of Bell blocks being distinguished as at least one of a previous Bell block or a next Bell block, depending on a sequence in which each of the plurality of Bell blocks is calculated −;
a selection unit including one or more processors and configured to select a Bell fusion operator to be applied to a next Bell block of the plurality of Bell blocks based on a result of measuring a zeroth level of Bell state for a previous Bell block corresponding to the next Bell block; and
an identification unit including one or more optical components and configured to identify a first level of Bell state for a Bell box including the plurality of Bell blocks based on a result of measuring a zeroth level of Bell state for each of the plurality of Bell blocks.

2. The apparatus of claim 1, wherein the Bell fusion operator includes at least two Bell fusion operators of a first Bell fusion operator configured to identify a first state of the zeroth level, a second Bell fusion operator configured to identify a second state of the zeroth level, or a third Bell fusion operator configured to identify a third state of the zeroth level.

3. The apparatus of claim 2, wherein the selection unit selects the second Bell fusion operator or the third Bell fusion operator as an operator to be applied to the next Bell block when a measurement of a zeroth level of Bell state for the previous Bell block by applying the first Bell fusion operator to the previous Bell block is successful or photon losses are detected.

4. The apparatus of claim 3, wherein the selection unit applies the second Bell fusion operator or the third Bell fusion operator to an entirety of the next Bell block simultaneously and all at once when the measurement of the zeroth level of Bell state for the previous Bell block by applying the first Bell fusion operator to the previous Bell block is successful or photon losses are detected.

5. The apparatus of claim 2, wherein the selection unit selects the first Bell fusion operator as an operator to be applied to the next Bell block when a measurement of a zeroth level of Bell state for the previous Bell block by applying the first Bell fusion operator to the previous Bell block fails.

6. The apparatus of claim 5, wherein the selection unit selects the second Bell fusion operator or the third Bell fusion operator as an operator to be applied to the next Bell block when the measurement of the zeroth level of Bell state for the previous Bell block by applying the first Bell fusion operator to the previous Bell block continuously fails for a preset number of times or more.

7. The apparatus of claim 6, wherein the selection unit applies the second Bell fusion operator or the third Bell fusion operator to an entirety of the next Bell block simultaneously and all at once when the measurement of the zeroth level of Bell state for the previous Bell block by applying the first Bell fusion operator to the previous Bell block continuously fails for a preset number of times or more.

8. The apparatus of claim 2, wherein the second Bell fusion operator is configured to identify a Bell state of a qubit that is indistinguishable via in the first Bell fusion operator, and
wherein the third Bell fusion operator is configured to identify a Bell state of a qubit that is indistinguishable via the first Bell fusion operator and the second Bell fusion operator.

9. The apparatus of claim 2, wherein the identification unit identifies a first level of Bell state for a Bell box including the plurality of Bell blocks based on a result of measuring the zeroth level of Bell state for each of the plurality of Bell blocks.

10. The apparatus of claim 9, wherein the identification unit identifies the first level of Bell state to be a state in which all input pairs of photons are entangled with each other when no photon losses are detected upon Bell state measurement for all of the plurality of Bell blocks by applying the first Bell fusion operator to each of the plurality of Bell blocks.

11. The apparatus of claim 9, wherein the identification unit determines signs of all input pairs of photons to identify the first level of Bell state when Bell state measurement for some of the plurality of Bell blocks is successful or photon losses are not detected by applying the first Bell fusion operator to each of the plurality of Bell blocks.

12. The apparatus of claim 7, wherein the identification unit identifies a second level of Bell state for a Bell network including the plurality of Bell boxes on the basis of a first level for each of the Bell boxes.
